(19) United States
(12) Patent Application Publication
(10) Pub. No.: US 2022/0256876 A1
(43) Pub. Date: Aug. 18, 2022

(54) PLANT-BASED MILK ALTERNATIVE WITH NEW TASTE EXPERIENCE

(71) Applicant: SOCIETE DES PRODUITS NESTLE S.A., Vevey (CH)

(72) Inventors: YUE WANG, Epalinges (CH); MARINA BORTOLIN, Beachwood, OH (US); MARGARITA MITROPOULOU, Twinsburg, OH (US)

(21) Appl. No.: 17/597,958

(22) PCT Filed: Jul. 29, 2020
(86) PCT No.: PCT/EP2020/071421

§ 371 Date: Jan. 31, 2022

(30) Foreign Application Priority Data
Jul. 31, 2019 (EP) 19189453.4

(51) Int. Cl. A23C 11/10; A23L 2/66; A23L 33/185; A23L 33/16; A23L 33/155

(52) U.S. Cl. CPC A23C 11/103; A23L 2/66; A23V 2002/00; A23L 33/16; A23L 33/155; A23L 33/185

(57) ABSTRACT

The present invention relates generally to the field of plant-based drinkable compositions. Such plant based drinkable compositions are often consumed to replace milk-based beverages. In particular, the present invention relates to plant-based compositions with a new taste experience, suitable for out-of-home consumption, for example, during the day. One embodiment of the present invention relates to a plant based composition, wherein said composition comprises water, glucose syrup from rice, pistachio puree, bean protein, lemon oil, and salt; and wherein said composition is a beverage.

The present invention relates generally to the field of plant-based drinkable compositions. Such plant based drinkable compositions are often consumed to replace milk-based beverages. In particular, the present invention relates to plant-based compositions with a new taste experience, suitable for out-of-home consumption, for example, during the day. One embodiment of the present invention relates to a plant based composition, wherein said composition comprises water, glucose syrup from rice, pistachio puree, bean protein, lemon oil and salt; and wherein said composition is a beverage.

Plant based beverages that can be used as milk alternatives are well-known in the art, and their consumption is increasing. Sales of such milk alternatives have surged around 10% over the past two years. This trend is not only driven by an increase in people following a vegan lifestyle. Also, non-vegan consumers increasingly choose plant-based milk alternatives. Typical representatives of such plant based milk alternatives are milk alternatives based on soy, oats, rice, coconut, almonds, hazelnut, or walnut for example.

Usually such milk alternatives are sold in packs that contain multiple servings and that are intended for in-home consumption. They are usually sold with plain taste, or are offered flavoured with well-known standard flavours such as chocolate or vanilla, for example.

In-home consumption of such milk alternatives limits the consumption occasions to breakfast in the morning and to evenings. It would therefore be desirable to extend the consumption occasions of such plant based compositions to consumption throughout the day, when people are out-of-home. Furthermore, as people undergo different emotional states during the day, it would be desirable, to have available compositions with taste profiles, that can satisfy the cravings resulting from these emotional states. For example, during the day people may experience moments of fatigue, where they wish for a refined, refreshing and balanced taste profile in a beverage.

It would therefore be desirable to provide the art with a plant-based beverage suitable for out-of-home consumption with a taste profile that allows people to satisfy their desires during such “fatigue”-moments.

The present inventors have addressed this need.

Any reference to prior art documents in this specification is not to be considered an admission that such prior art is widely known or forms part of the common general knowledge in the field.

The objective of the present invention is to improve or enrich the state of the art and in particular to provide the art with a plant-based beverage suitable for out-of-home consumption with a taste profile that allows people to satisfy their desires during such “fatigue”-moments, or to at least provide a useful alternative.

The inventors were surprised to see that the objective of the present invention could be achieved by the subject matter of the independent claim. The dependent claims further develop the idea of the present invention.

Accordingly, the present invention provides a plant based composition, wherein said composition is a beverage and comprises water, glucose syrup from rice, pistachio puree, bean protein, lemon, and salt.

As used in this specification, the words “comprises”, “comprising”, and similar words, are not to be interpreted in an exclusive or exhaustive sense. In other words, they are intended to mean “including, but not limited to”.

The present inventors have conducted intensive studies and were surprised to see that they had developed a flavour combination leading to a plant-based beverage that allows people to satisfy their desires during “fatigue”-moments and that can be offered for out-of-home consumption. The present inventors were thus satisfied to see that the composition claimed in the present invention achieves the objective of the present invention.

The invention relates to a plant based composition, wherein said composition comprises water, glucose syrup from rice, pistachio puree, bean protein, lemon extract, and salt; said composition is a beverage; and said composition has an energy content per 100 ml in the range of 190-230 kJ, for example of about 211 kJ.

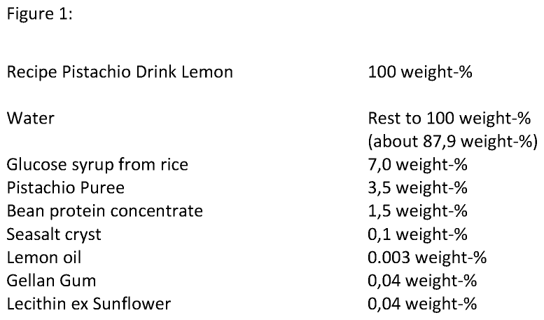

FIG. 1 shows one example of a recipe that the inventors have developed and prepared that achieves the objective of the present invention.

Consequently the present invention relates in part to a plant-based composition, wherein
said composition comprises water, glucose syrup from rice, pistachio puree, bean protein, lemon oil, and salt,
said composition is a beverage, and
said composition has an energy content per 100 ml in the range of 190-230 kJ, for example of about 211 kJ.

The composition of the present invention is a plant-based composition.

The term “plant based” shall be understood for the purpose of the present invention to comprise parts of plants that are consumed by humans or other animals as food, for example fruits, nuts and/or vegetables. For the purpose of the present invention, a composition shall be considered plant based, if it contains at least 50 weight-% plant protein, for example at least 75 weight-% plant protein, or at least 95 weight-% plant protein.

The plant-based composition may be a milk alternative. The term “milk alternative” shall be understood for the purpose of the present invention as liquids that resemble milk or flavoured milk.

The composition of the present invention is a beverage. Beverages have the advantage that they can be easily consumed without the need of utensils such as a spoon, for example, and are, hence, effortless to consume, both, at home and “on the go”.

The unique combination of glucose syrup from rice, pistachio puree, bean protein, lemon oil, and salt leads to a plant based beverage with a taste profile that allows satisfying the needs during “fatigue”-moments during the day.

The energy content of the composition of the present invention is below the energy content of regular milk, while still providing sufficient energy to recharge the body in case of need. This has the advantage that composition of the present invention can be used to recharge the body and to indulge in taste without overindulging in caloric content.

The plant based composition according to the present invention may have per 100 ml a fat content of 1.6-2.0 g, for example about 1.8 g, a carbohydrate content of 6.2-6.6 g, for example about 6.4 g, a protein content of 1.6-2.0 g, for example about 1.8 g, and a salt content of 0.04-0.08 g, for example about 0.06 g. This makes the composition of the present invention nutritionally valuable.

The composition of the present invention may have a per 100 ml a saturated fat content of 0.1-0.3 g, for example about 0.2 g and a sugar content of 4.1-4.5 g, for example about 4.3 g.

As the new taste experience is a key element that led to the subject matter of the present invention; and the composition of the present invention can be used to satisfy people during “fatigue” moments, it is preferred, if ingredients of high quality are used in the composition of the present invention. For example, the salt may be provided as sea salt.

Additives may be used to further improve the experience during the consumption of the composition of the present invention. For example, stabiliser E418, gellan gum may be used. Gellan gum may be used to provide a thicker mouth-feel. Lecithins, for example lecithins derived from sunflower, can be used as emulsifier. In one embodiment, the composition of the present invention further comprises emulsifier lecithins and/or stabiliser E418.

While the unique combination of glucose syrup from rice, pistachio puree, bean protein, lemon oil, and salt leads to a plant based beverage with a taste profile that achieves the objective of the present invention, the inventors have obtained the best results when the plant based composition according to the present invention comprises
3.0-4.0 weight-%, for example about 3.5 weight-%, pistachio puree;
6.0-8.0 weight-%, for example about 7.0 weight-%, glucose syrup from rice;
0.05-0.15 weight-%, for example about 0.1 weight-%, sea salt;
1.0-2.0 weight-%, for example about 1.5 weight-%, bean protein concentrate;
0.001-0.004 weight-%, for example about 0.003 weight-% lemon oil; and
85-90 weight-%, for example about 87.9 weight-% water.

The plant based composition according to the present invention may be fortified. For the purpose of the present invention, the term “fortified” shall mean that nutrients, vitamins and/or minerals are added to the composition of the present invention at higher levels than what the original food ingredients provide. In accordance with Codex Alimentarius, the term “food” shall mean for the purpose of the present invention any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

For example, the composition of the present invention may be fortified with nutrients, vitamins and/or minerals to even better meet the nutritional requirements of people consuming the composition of the present invention.

It is within the skill of a person skilled in the art to appropriately select nutrients, vitamins and/or minerals accordingly. For example, nutrients, vitamins and/or minerals may be selected from the group consisting of zinc sulfate, calcium lactate, potassium iodide, vitamin D3, vitamin B12 and any mixture of any of the foregoing. The composition of the present invention may be also further fortified with Zinc, Vitamin B12 and/or Vitamin D. Vitamin D, for example vitamin D3, may be vegan vitamin D or vegan vitamin D3, respectively.

In one embodiment of the present invention, the composition of the present invention is fortified with zinc sulfate, calcium lactate, potassium iodide, vitamin D, and vitamin B12. This has the advantage that the composition of the present invention is very well fortified to address needs that might arise from a vegan, vegetarian or flexitarian diet.

Zinc is an important micronutrient that plays, e.g., a role in immunity and is available from many animal sources. It is also available from plant sources, such as tomatoes, seeds, mushrooms, whole grains, lentils and beans, for example. However, since plant sources of zinc often contain inhibitors of zinc absorption, such as phytate, for example, there is a risk of zinc deficiency. Consequently, fortification with zinc may be advisable. Zinc can be provided, for example in the form of zinc sulfate, which is commercially available.

The body needs iodine, e.g., to make thyroid hormones. Iodine is present in fish, eggs or dairy products, for example. Vegan iodine sources include for example seaweed, however, sufficient iodine supply needs to be ensured. Iodine can be provided, for example in the form of potassium iodide, which is commercially available.

Vitamin D is present, e.g., in fatty fish, beef liver, or cheese and it is produced endogenously when exposed to UV. It is involved in the regulation of blood calcium and phosphorus levels and thus plays an important role in bone health. Plant-based vitamin D is available from mushrooms, for example. If people do not spend sufficient time outside or during winter, there is a risk of vitamin D deficiency. Consequently, fortification with vitamin D may be advisable. Vitamin D is commercially available. Vitamin D3, or cholecalciferol, is a vitamin D and plays a role in the regulation of healthy bones, muscle, immune system, insulin and metabolism. It is generally believed to be more potent than vitamin D2. Consequently, fortification with vitamin D3 may be advisable. Vitamin D3 is commercially available.

Vitamin B12 is important in the normal functioning of the nervous system due to its role in the synthesis of myelin, and in the maturation of developing red blood cells in the bone marrow. It is naturally found in animal products such as shellfish, fish, meat, poultry, eggs, milk, and milk products. However, vitamin B12 is generally not present in plant-based foods, unless they were fortified with vitamin B12. Consequently, fortification with vitamin B12 may be advisable. Vitamin B12 is commercially available.

The composition of the present invention may be designed so that it is specifically suitable for the nutritional requirements of a flexitarian, a vegetarian or a vegan. For the purpose of the present invention, the term “vegan” diet shall mean a diet abstaining from the use of animal products. For the purpose of the present invention, the term “vegetarian” diet shall mean a diet abstaining from the consumption of meat or fish. For the purpose of the present invention, the term “flexitarian” diet shall mean a normal diet abstaining in regular intervals from meat or fish.

Hence, in one embodiment of the present invention the composition of the present invention is suitable for consumption by a vegan and/or to be consumed by a vegan. In another embodiment of the present invention the composition is suitable for consumption by a vegetarian and/or to be consumed by a vegetarian. In a further embodiment of the present invention the composition is suitable for consumption by a flexitarian and/or to be consumed by a flexitarian.

Consequently, the composition according to the present invention may comprise iron in an amount of 1.5-9 mg/100 g of the composition, zinc in an amount of 1-8 mg/100 g of the composition, vitamin B12 in an amount of 2-7 μg/100 g of the composition, and vitamin D in an amount of 3-20 μg/100 g of the composition.

For example, the composition according to the present invention may comprise iron in an amount of 1.5-5 mg/100 g of the composition, zinc in an amount of 1-4 mg/100 g of the composition, vitamin B12 in an amount of 2-7 μg/100 g of the composition, and vitamin D in an amount of 3-10 μg/100 g of the composition.

Further for example, the composition according to the present invention may comprise iron in an amount of 2-3 mg/100 g of the composition, zinc in an amount of 1-2 mg/100 g of the composition, vitamin B12 in an amount of 2-3 μg/100 g of the composition, and vitamin D in an amount of 4-6 μg/100 g of the composition.

Further, for example, the composition according to the present invention may comprise iron in an amount of about 2.1 mg/100 g of the composition, zinc in an amount of about 1.5 mg/100 g of the composition, vitamin B12 in an amount of about 2.5 μg/100 g of the composition, and vitamin D in an amount of about 5 μg/100 g of the composition.

One advantage of the composition of the present invention is that it does not need to contain lactose and is, hence, well suited for consumers suffering from lactose intolerance. Hence, in one embodiment of the present invention, the plant based composition according to the present invention is lactose-free.

The composition of the present invention may be sold for consumption out-of-home. As such, the plant based composition according to the present invention may be provided in a single-serve packaging. Suitable single serve packagings are well-known to the person skilled in the art. Such a single-serve packing may be a plastic bottle, a glass bottle or a carton, for example. Advantageously, such a single serve packaging is re-usable, recyclable, compostable or bio-degradable for example. Further, for example, such a single serve packaging may not contain a plastic straw. For example, the composition of the present invention may be provided as a 200 ml recyclable PET bottle. Hence, the subject matter of the present invention extends to a single serve packaging, such as a recyclable single serve PET bottle, for example, comprising the plant based composition in accordance with the present invention.

Accordingly, the plant based composition according to the present invention may be to be provided as ready-to-drink composition for consumption out-of-home.

In one embodiment of the present invention, the plant based composition according to the present invention may be to be supplied through the ambient channel. This has the advantage that the composition of the present invention can be transported for longer distances without the need for cooling. Further, such ambient compositions are easier to handle on-the-go.

Those skilled in the art will understand that they can freely combine all features of the present invention disclosed herein. Features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

The inventors have prepared several plant based beverages, among them the composition shown in FIG. 1, and have assessed their taste profiles with a panel of 8 experts. The inventors were surprised that the composition of the present invention, for example the composition according to the recipe of FIG. 1 performed particularly well in achieving the objective of the present invention.

1. A plant based composition, wherein
said composition consisting essentially of water, glucose syrup from rice, pistachio puree, bean protein, lemon oil, and salt,
said composition is a beverage, and
said composition has an energy content per 100 ml in the range of 190-230 kJ.

2. A plant based composition according to claim 1, wherein the composition has per 100 ml a fat content of 1.6-2.0 g, a carbohydrate content of 6.2-6.6 g, a protein content of 1.6-2.0 g, and a salt content of 0.04-0.08 g.

3. A plant based composition according to claim 1, wherein the composition has per 100 ml a saturated fat content of 0.1-0.3 g, and a sugar content of 4.1-4.5 g.

4. A plant based composition according to claim 1, wherein the salt is provided as sea salt.

5. A plant based composition according to claim 1, wherein the wherein the composition further comprises emulsifier lecithins and/or stabiliser E418.

6. A plant based composition according to claim 1, wherein the wherein the composition comprises
3.0-4.0 weight-%, pistachio puree;
6.0-8.0 weight-%, glucose syrup from rice;
0.05-0.15 weight-%, sea salt;
0.001-0.004 weight-%, lemon oil;
1.0-2.0 weight-%, bean protein concentrate; and
85-90 weight-%, water.

7. A plant based composition according to claim 1, wherein the composition is fortified with nutrients, vitamins and/or minerals.

8. A plant based composition according to claim 7, wherein the nutrients, vitamins and/or minerals are selected from the group consisting of zinc sulfate, calcium lactate, potassium Iodide, vitamin D3, vitamin B12 and any mixture of any of the foregoing.

9. A plant based composition according to claim 7, wherein the fortified plant based composition is further fortified with Zinc, Vitamin B12 and Vitamin D.

10. A plant based composition according to claim 1, wherein composition is suitable for consumption by a vegetarian or vegan.

11. A plant based composition according to claim 1, wherein composition is lactose-free.

12. A plant based composition according to claim 1, wherein composition is provided in a single-serve packaging.

13. A plant based composition according to claim 1, wherein composition is provided as ready-to-drink composition for consumption out-of-home.

14. A plant based composition according to claim 1, wherein composition is to be supplied through the ambient channel.
